(19) United States
(12) Patent Application Publication
(10) Pub. No.: US 2011/0157465 A1
(43) Pub. Date: Jun. 30, 2011

(54) LOOK UP TABLE UPDATE METHOD

(75) Inventors: Po Jung Lin, Kaohsiung City (TW); Da Ming Chang, Kaohsiung City (TW)

(73) Assignee: ALTEK CORPORATION, Hsinchu (TW)

(21) Appl. No.: 12/723,855

(22) Filed: Mar. 15, 2010

(30) Foreign Application Priority Data
Dec. 30, 2009 (TW) 098146009

(51) Int. Cl. H04N 7/01

(52) U.S. Cl. 348/448; 348/E07.003

(57) ABSTRACT

An update method for look up table (LUT) is suitable for an image processing apparatus. The image processing apparatus includes a multiple-interpolation lookup table device having an execution LUT, and the LUT update method updates the multiple-interpolation lookup table device according to a source LUT. The update method includes the steps of dividing the source LUT into a plurality of sub LUTs; and using the sub LUTs to respectively update content of the execution LUT in a plurality of vertical blanking intervals (VBIs).

### CROSS-REFERENCE TO RELATED APPLICATIONS

This non-provisional application claims priority under 35 U.S.C. §119(a) on Patent Application No(s). 098146009 filed in Taiwan, R.O.C. on Dec. 30, 2009, the entire contents of which are hereby incorporated by reference.

### BACKGROUND OF THE INVENTION

1. Field of Invention

The present invention relates to a look up table (LUT) update method, and more particularly to an LUT update method of an image processing apparatus.

2. Related Art

A user can use a digital camera or video camera to capture images or video, and obtain image/video output files that can be directly played and viewed. However, data initially obtained by a sensor of a camera or other apparatuses is raw data, and the raw data cannot be provided to the user for view before many processing operations performed by an image processing apparatus. In the image processing, the image processing apparatus usually looks up various look up tables (LUTs) in order to accelerate the processing. The reason is that, an LUT is equivalent to a memory that stores results in the form of an array, and the corresponding result can be found according to an index, so that complex computation can be avoided, thereby saving the time and improving the efficiency.

If the user changes shooting environment parameters, content of the LUT needs to be updated accordingly. In addition, with the development of technologies, the user has higher requirements for the image quality requirements, so that more details needs to be written into the LUT. In other words, when the LUT is updated, more time will be taken to write more data. As such, it is possible that the LUT cannot be updated in real time during video processing, resulting in an error in image processing.

In a conventional LUT update method, an LUT is updated in vertical blanking intervals (VBIs) when video frames are scanned, that is, the LUT is updated in an interval for switching frames. However, since the image processing apparatus has a complicated system and has to perform many operations other than updating the LUT when the shooting environment parameters are changed, it is difficult to complete the updating of the LUT within the VBIs, and as a result, an error occurs when a next frame is processed. In addition, as the frame rate desired by the user becomes higher, the time of the VBIs becomes shorter so errors more easily occur.

In another conventional LUT update method, a group of shadow tables are added. When a current frame is processed, content of the LUT required by a next frame is stored in the shadow table in advance. Then, the shadow table with the updated content is switched to for use by the next frame. However, this method requires an additional group of registers or memories, resulting in higher hardware cost and power consumption. In addition, the additional registers or memories required by a plurality of LUTs may be up to 10 kilobytes (kb), which greatly increases the cost of the image processing apparatus.

### SUMMARY OF THE INVENTION

To solve the above problems, the present invention provides an LUT update method, which is suitable for an image processing apparatus. The image processing apparatus comprises a multiple-interpolation lookup table device having an execution LUT, and the LUT update method updates the multiple-interpolation lookup table device according to a source LUT. The LUT update method is to distribute LUT content to be updated into different VBIs, which not only overcomes the defect in the prior art that additional registers or memories are needed, but also enables the lookup table device to have multiple interpolation precisions.

The LUT update method of the present invention comprises: dividing a source LUT into a plurality of sub look up tables (sub LUTs); and using the sub LUTs to respectively update content of an execution LUT in a plurality of VBIs.

According to an embodiment of the present invention, the sub LUTs are each corresponding to an N-point interpolation method. The execution LUT is updated by the sub LUTs such that the multiple-interpolation lookup table device is corresponding to the N-point interpolation methods, in which N is 2^{m}, where m is an integer equal to or greater than 1.

According to an embodiment of the present invention, the execution LUT is divided into a plurality of index segments, and the sub LUTs are respectively corresponding to the index segments, so as to respectively update the corresponding index segments in the VBIs.

The sub LUTs are each corresponding to an N-point interpolation method. The index segments are updated by the sub LUTs such that the index segments of the multiple-interpolation lookup table device are corresponding to the N-point interpolation methods, in which N is 2^{m}, where m is an integer equal to or greater than 1.

Moreover, after the execution LUT is updated by the sub LUTs, the index segments of the execution LUT are corresponding to the different N-point interpolation methods at the same time.

Based on the above, the LUT update method of the present invention gradually updates the execution LUT of the multiple-interpolation lookup table device in the plurality of VBIs. When the shooting environment parameters are changed, the multiple-interpolation lookup table device can provide the result of the execution LUT in real time through the N-point interpolation methods. Furthermore, as the execution LUT is gradually updated, the multiple-interpolation lookup table device can provide more precise interpolation results. Moreover, the LUT update method of the present invention does not require any additional registers or memories, and thus has low cost and low power consumption compared with the conventional update methods.

### BRIEF DESCRIPTION OF THE DRAWINGS

The present invention will become more fully understood from the detailed description given herein below for illustration only, and thus are not limitative of the present invention, and wherein:

FIG. 1 is a schematic block diagram of an image processing apparatus according to an embodiment of the present invention;

FIG. 2 is a schematic view of VBIs according to an embodiment of the present invention;

FIG. 3 is a schematic flow chart of an LUT update method according to an embodiment of the present invention;

FIG. 4 is a schematic view of a source LUT according to an embodiment of the present invention;

FIG. 5A is a schematic view of index values and target values of an updated execution LUT according to an embodiment of the present invention;

FIG. 5B is a schematic view of index values and target values of an updated execution LUT according to an embodiment of the present invention;

FIG. 5C is a schematic view of index values and target values of an updated execution LUT according to an embodiment of the present invention;

FIG. 5D is a schematic view of index values and target values of an updated execution LUT according to an embodiment of the present invention;

FIG. 5E is a schematic view of index values and target values of an updated execution LUT according to an embodiment of the present invention;

FIG. 6 is a schematic flow chart of a process for updating an execution LUT according to an embodiment of the present invention;

FIG. 7 is a schematic flow chart of an LUT update method according to another embodiment of the present invention;

FIG. 8 is a schematic flow chart of a process for updating an execution LUT according to an embodiment of the present invention; and

FIG. 9 is a schematic view of index values and target values of an updated execution LUT according to another embodiment of the present invention.

### DETAILED DESCRIPTION OF THE INVENTION

The detailed features and advantages of the present invention are described below in detail through the following embodiments, and the content of the detailed description is sufficient for those skilled in the art to understand the technical content of the present invention and to implement the present invention accordingly. Based upon the content of the specification, the claims, and the drawings, those skilled in the art can easily understand the objectives and advantages of the present invention.

The present invention provides an LUT update method, which is suitable for an image processing apparatus. The image processing apparatus comprises a multiple-interpolation lookup table device having an execution LUT. The image processing apparatus may be a digital camera, a video camera, a mobile phone with a camera function, or other apparatuses having an image processing function. Definitely, the LUT update method of the present invention is also applicable to systems having the image processing function, for example, computer systems such as desktop computers or servers.

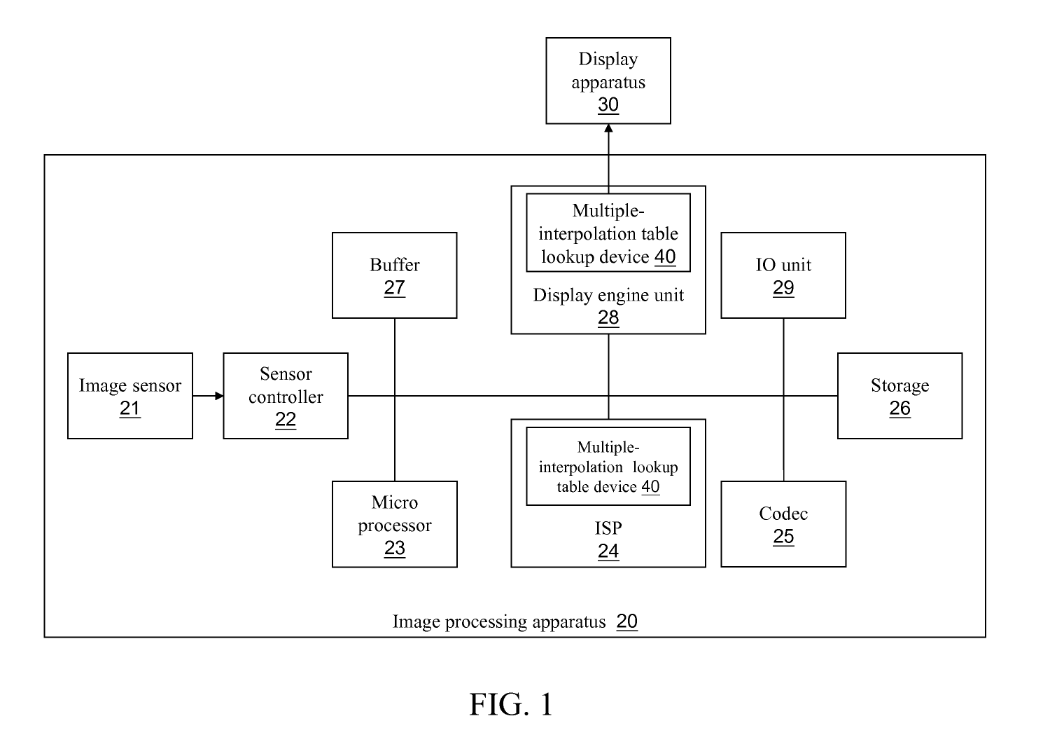

FIG. 1 is a schematic block diagram of an image processing apparatus according to an embodiment of the present invention. The image processing apparatus 20 to which the present invention is applicable may be, but is not limited to, the architecture shown in FIG. 1. Referring to FIG. 1, the image processing apparatus 20 comprises an image sensor 21, a sensor controller 22, a micro processor 23, an image signal processor (ISP) 24, a codec 25, a storage 26, a buffer 27, a display engine unit 28, and an input/output (IO) unit 29.

The image sensor 21 is used for sensing images, and may be, for example, an image capturing unit or optical image sensor of a digital camera, mobile phone, video camera or other apparatuses. For example, the image sensor 21 may be a charge coupled device (CCD) or a complementary metal-oxide-semiconductor (CMOS) optical sensor.

The sensor controller 22 is capable of generating high-speed control signals to control the image sensor 21. The micro processor 23 is used for controlling operations of the image processing apparatus 20 and elements thereof. The buffer 27 is used for temporarily storing data, such that when the micro processor 23 needs the data, the micro processor 23 may directly invoke the data from the buffer 27, so as to improve the execution performance of the micro processor 23.

The ISP 24 processes an image signal according to many procedures, and the processed image may be stored in the storage 26, and then displayed on a display apparatus 30 electrically connected to the image processing apparatus 20 via the display engine unit 28. In addition, the ISP 24 and the display engine unit 28 of the present invention each comprise a multiple-interpolation lookup table device 40 having an execution LUT. The multiple-interpolation lookup table device 40 has multiple interpolation precisions, that is, the multiple-interpolation lookup table device 40 is corresponding to an N-point interpolation method. For example, the multiple-interpolation lookup table device 40 may support a 2-point interpolation method, a 4-point interpolation method, an 8-point interpolation method, or a 16-point interpolation method, so as to obtain a target value corresponding to an index value through interpolation according to the index value of the execution LUT. In addition, the storage 26 stores a source LUT for updating content of the execution LUT of the multiple-interpolation lookup table device 40.

Taking a digital camera for example, when a user changes shooting environment parameters, for example, switches a still image capturing mode to a video recording mode, the execution LUT needs to be updated. Moreover, when the user changes the International Organization for Standardization (ISO), auto white balance (AWB), or scene mode of the camera, or when the user changes the display apparatus 30 connected to the image processing apparatus 20, the execution LUT needs to be updated.

According to an embodiment of the present invention, the source LUT and the execution LUT may each be a red-green-blue (RGB) table, a luminance-chrominance (YUV) table, an AWB table, a linear to non-linear table, a non-linear to linear table, or a lens shading table.

Furthermore, the display apparatus 30 may be built in the image processing apparatus 20 or externally connected to the image processing apparatus 20, for example, a television screen. The storage 26 may be an external storage, which not only stores processed image data, but can also stores unprocessed image data. Preferably, the storage 26 is a dynamic random access memory (DRAM) or a double data rate synchronous dynamic random access memory (DDR SDRAM, also referred to as DDR in short).

The codec 25 is used for coding and compressing or decoding and decompressing an image signal, and is, for example, capable of converting an image into an Audio Video Interleave (AVI) format, a Moving Picture Experts Group (MPEG) format, or other video formats.

The IO unit 29 may be, for example, a control unit of an external memory card, and is used for storing processed video data into the memory card. The memory card may be a Secured Digital (SD) card, a Memory Stick (MS) memory card, a Compact Flash (CF) memory card, etc.

The LUT update method of the present invention is described in further detail below with reference to the image processing apparatus 20. The LUT update method is mainly to distribute content of the execution LUT of the multiple-interpolation lookup table device 40 to be updated into different VBIs for updating.

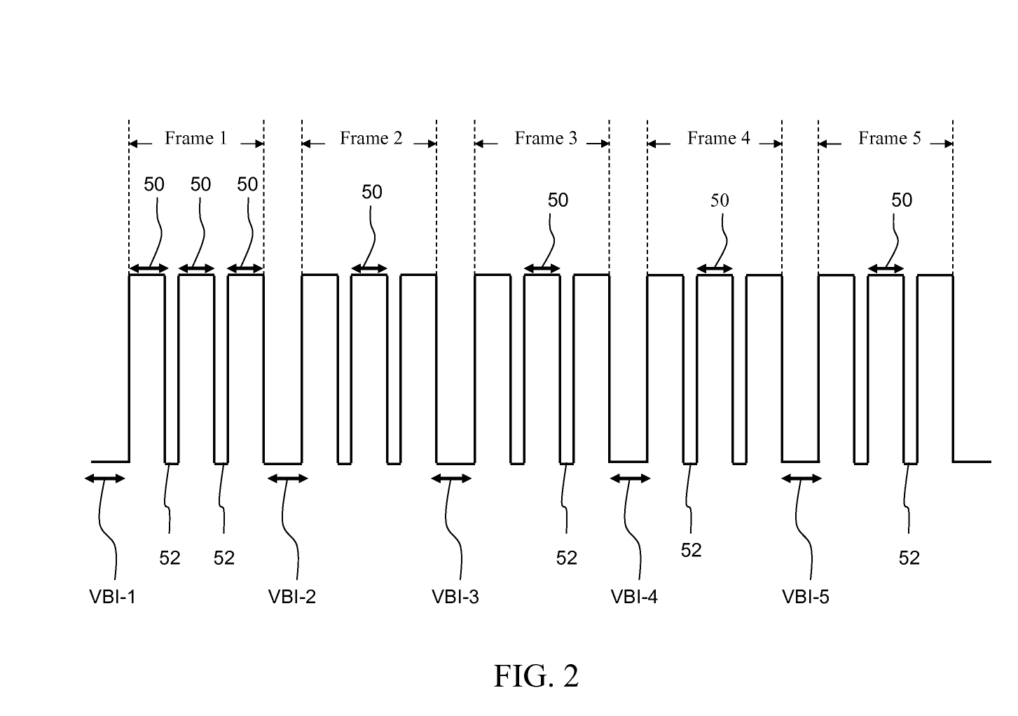

FIG. 2 is a schematic view of VBIs according to an embodiment of the present invention. Referring to FIG. 2, an image captured by the image sensor 21 has a plurality of frames, namely, a frame 1, a frame 2, a frame 3, a frame 4, and a frame 5. Each frame has a plurality of rows of image data 50, so that when the frame is read, the image data 50 is scanned and read sequentially row by row. Taking the frame 1 for example, after one row of image data 50 of the frame 1 is read and before the reading process proceeds to the starting point of a next row of image data 50, a short time interval exists. The time interval is referred to as a horizontal blanking interval (HBI) 52. A VBI is an interval after all image data 50 in one frame of video is read and before the reading process proceeds to the first row of image data 50 of a next frame. For example, when the frame 1 is switched to the next frame 2, a time difference between the two frames is a VBI-2.

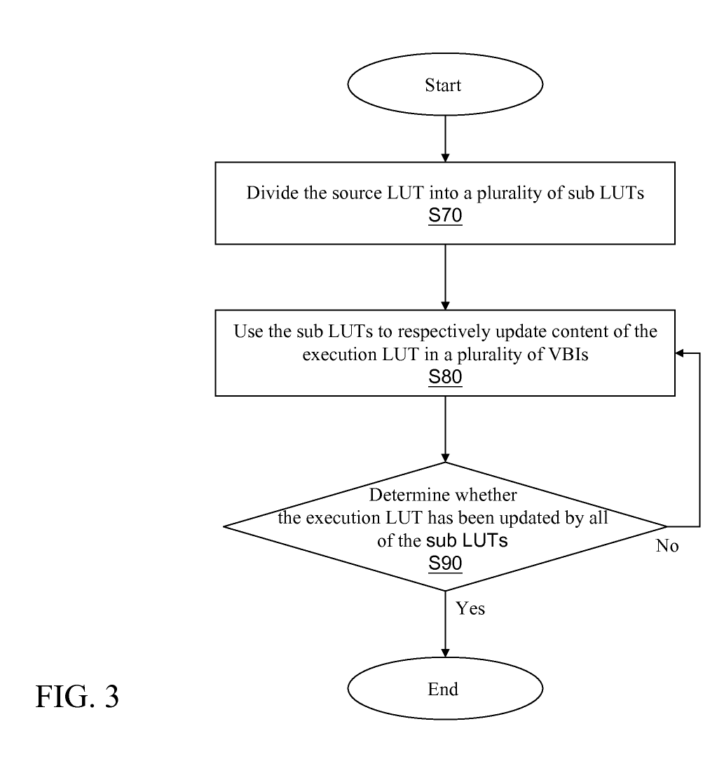

FIG. 3 is a schematic flow chart of an LUT update method according to an embodiment of the present invention. Referring to FIG. 3, the LUT update method comprises: Step S70, dividing the source LUT into a plurality of sub look up tables (sub LUTs); Step S80, using the sub LUTs to respectively update content of the execution LUT in a plurality of VBIs; and Step S90, determining whether the execution LUT is updated by all of the sub LUTs.

The source LUT used in the LUT update method is stored in the storage 26. When the user changes shooting environment parameters through an operation interface of the image processing apparatus 20, the content of the execution LUT of the multiple-interpolation lookup table device 40 needs to be updated accordingly. At this time, the micro processor 23 sends an update command to the ISP 24, so as to further update the content of the execution LUT in the multiple-interpolation lookup table device 40 according to content of the source LUT stored in the storage 26. Alternatively, when the user changes the display apparatus 30 connected to the image processing apparatus 20, the multiple-interpolation lookup table device 40 in the display engine unit 28 needs to be updated. At this time, the micro processor 23 sends an update command to the display engine unit 28, so as to update content of the execution LUT of the multiple-interpolation lookup table device 40 in the display engine unit 28 according to the source LUT stored in the storage 26.

According to an embodiment of the present invention, the source LUT may be an RGB table, a YUV table, an AWB table, a linear to non-linear table, a non-linear to linear table, a lens shading table, a liquid crystal display (LCD) gamma correction table, or a television gamma correction table.

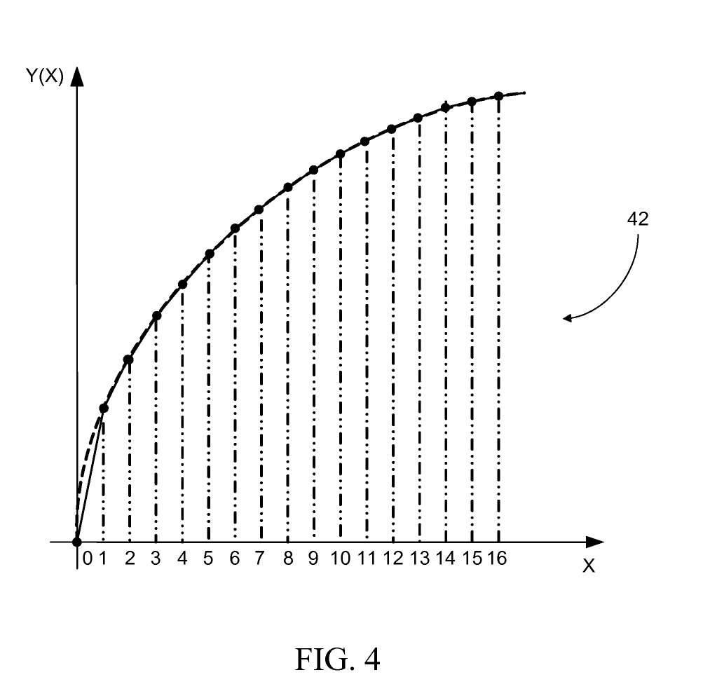

FIG. 4 is a schematic view of a source LUT according to an embodiment of the present invention. In FIG. 4, index values (x values) and target values (y values) of the source LUT 42 are represented by plotted points, and physical meanings of x and y axes are determined by the content of the source LUT 42. Taking a linear to non-linear table for example, x values represent linear images, and y values represent non-linear images. In this embodiment, the source LUT 42 has a storage capacity of 4 bits, and has 17 sets of index values and target values in total, that is, comprises target value data of index values x=0-16.

In Step S70, the source LUT 42 is divided into a plurality of sub LUTs, so as to use the sub LUTs to update the execution LUT sequentially.

Then, in Step S80, since a plurality of VBIs exits between a plurality of frames, as indicated by the frame 1, the frame 2, the frame 3, the frame 4, the frame 5, VBI-1, VBI-2, VBI-3, VBI-4, and VBI-5 shown in FIG. 2, the ISP 24 distributes the content of the execution LUT to be updated into different VBIs for updating. That is, the content of the execution LUT is sequentially updated in different VBIs according to the sub LUTs, respectively.

In detail, when the execution LUT is updated, each sub LUT may update all of the content of the execution LUT at a time, that is, copy the content of the sub LUT to the execution LUT of the multiple-interpolation lookup table device 40. In addition, when the sub LUT used in this VBI is corresponding to an N-point interpolation method (in other words, the sub LUT supports the N-point interpolation method), the execution LUT is updated by the sub LUT corresponding to the N-point interpolation method, such that the multiple-interpolation lookup table device 40 is also corresponding to the N-point interpolation method. That is, the multiple-interpolation lookup table device 40 has N-point interpolation precision, which enables the multiple-interpolation lookup table device 40 to become a lookup table device supporting the N-point interpolation method. As such, target values that have not been updated by the sub LUT can be obtained according to the N-point interpolation method. Here, N is 2^{m}, where m is an integer equal to or greater than 1.

For example, when the sub LUT used in this VBI supports a 2-point interpolation method, the execution LUT is updated by the sub LUT supporting the 2-point interpolation method, and thus has 2-point interpolation precision. At this time, the multiple-interpolation lookup table device 40 is a lookup table device supporting the 2-point interpolation method, that is, capable of obtaining target values by the 2-point interpolation method. Likewise, when the sub LUT used in this VBI supports a 4-point interpolation method, the execution LUT is updated by the sub LUT supporting the 4-point interpolation method, and thus has 4-point interpolation precision. At this time, the multiple-interpolation lookup table device 40 is a lookup table device supporting the 4-point interpolation method, that is, capable of obtaining target values by the 4-point interpolation method. The rest may be deduced by analogy.

Furthermore, the source LUT 42 may be divided according to the length of the VBI or the number of the execution LUTs that needs to be updated in the VBI. For example, if the VBI is long, it indicates that a large number of operations can be performed in the VBI, so that the source LUT 42 can be divided into a small number of sub LUTs. However, if a plurality of the execution LUTs in the ISP 24 or the display engine unit 28 needs to be updated at the same time, it indicates that each execution LUT can be provided with a short operation time, so that the source LUT 42 needs to be divided into a large number of sub LUTs and be updated gradually.

Finally, in Step S90, it is determined whether the execution LUT has been updated by all of the sub LUTs. If the execution LUT of the multiple-interpolation lookup table device 40 has been completely updated (that is, the content of the source LUT 42 has been completely copied to the execution LUT), the execution LUT does not need to be updated before a new update command is received. If the sub LUTs have not been completely copied to the execution LUT, the execution LUT is continuously updated in the next VBI until the multiple-interpolation lookup table device 40 has been updated by all of the sub LUTs.

It should be noted that, even if the execution LUT has not been completely updated, if a new update command is received, the multiple-interpolation lookup table device 40 needs to be updated again by a newly specified source LUT 42 according to the new update command.

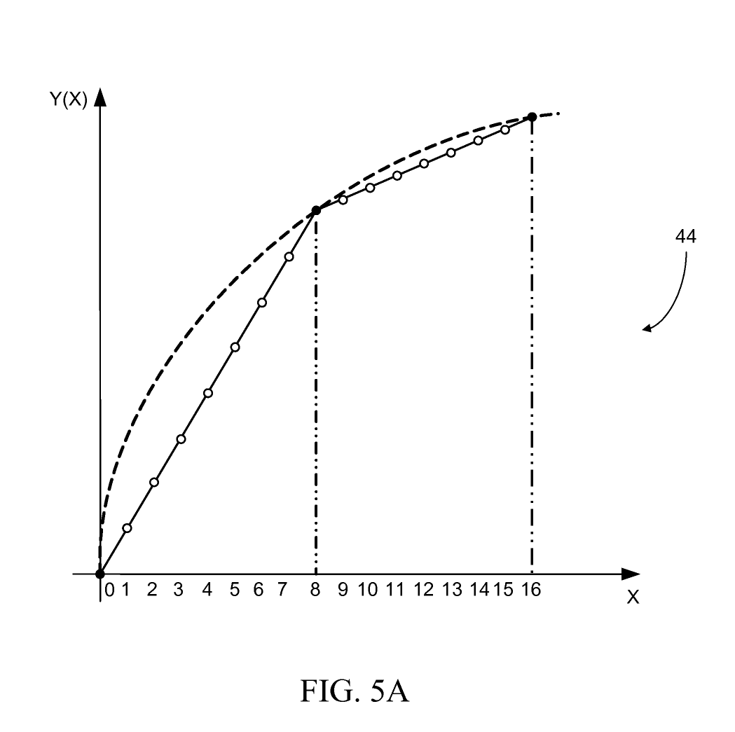

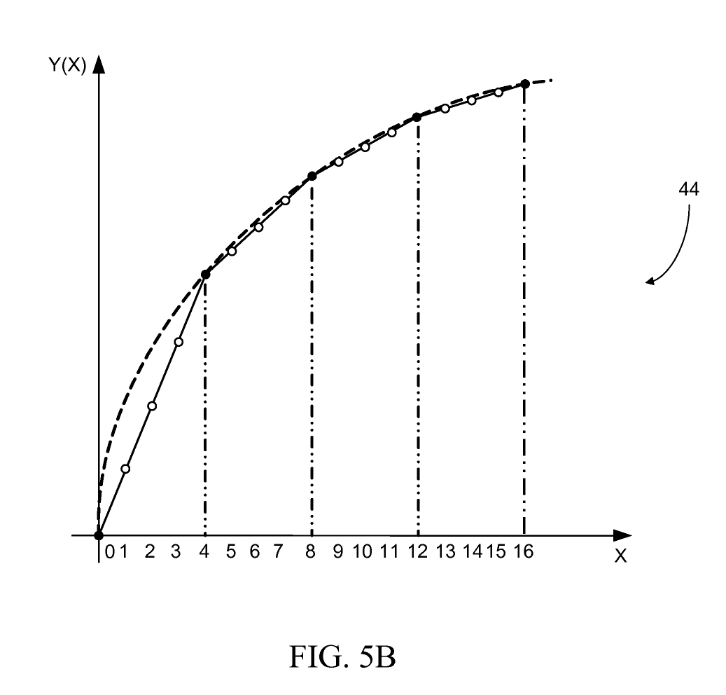

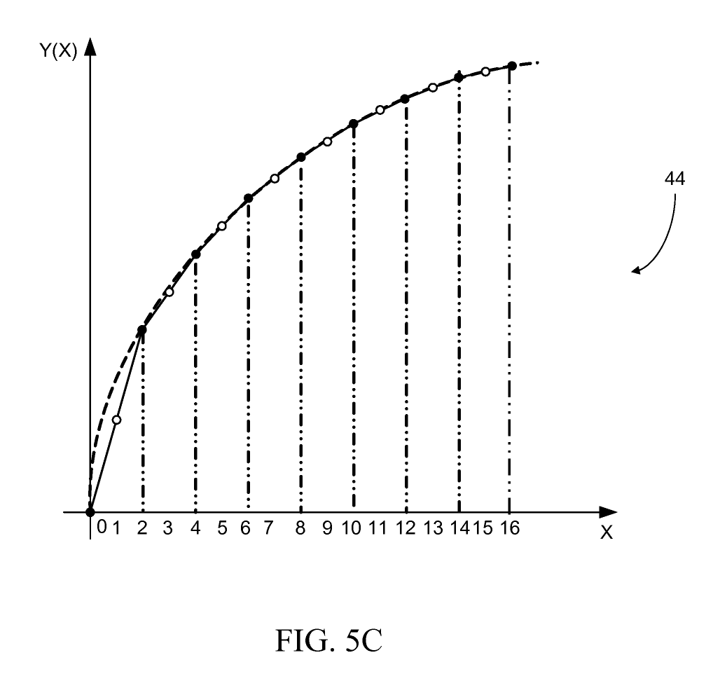

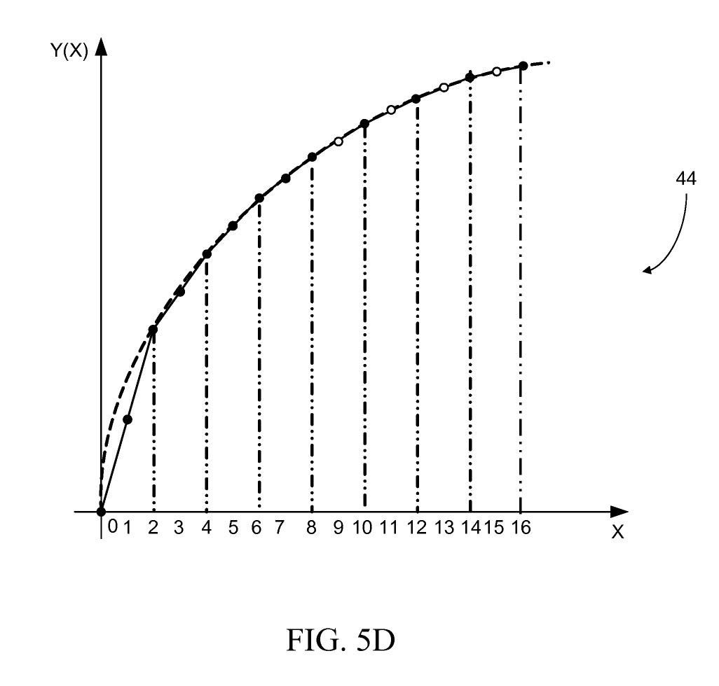

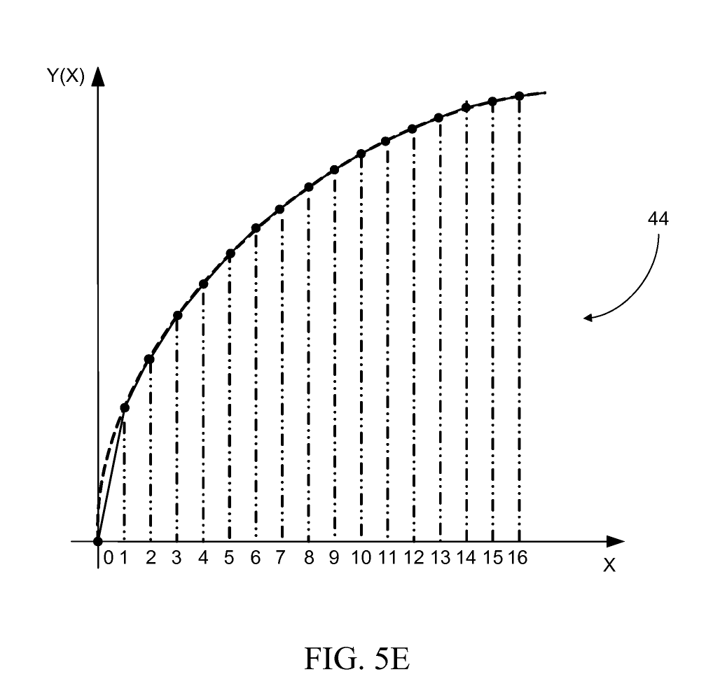

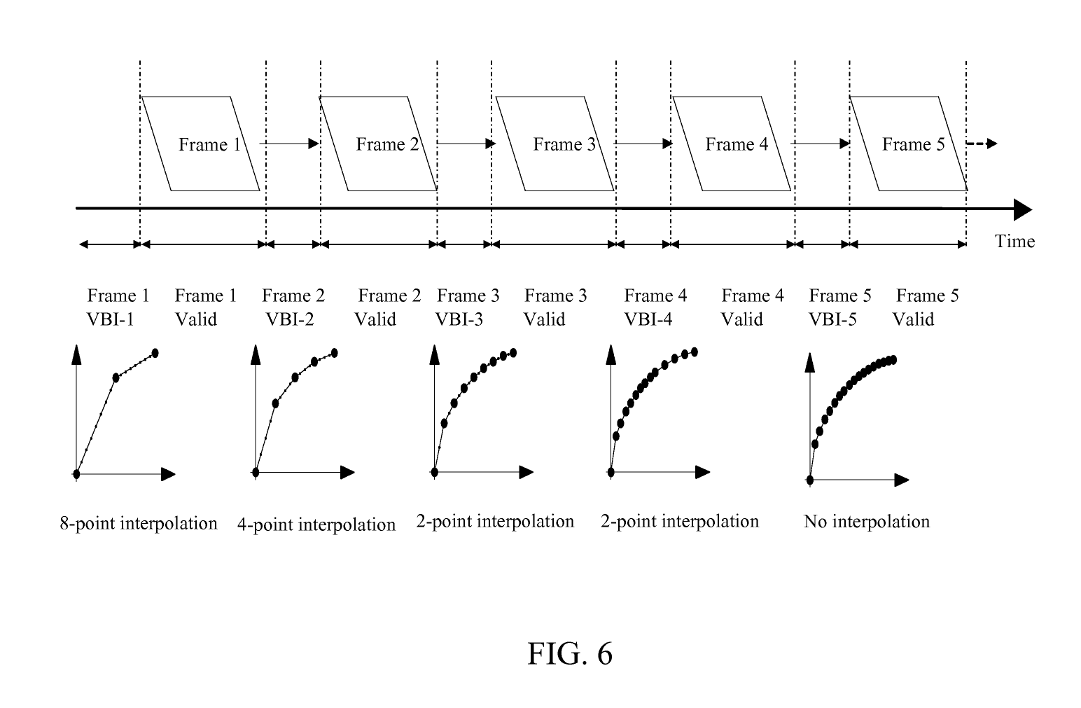

FIGS. 5A, 5B, 5C, 5D, and 5E are each a schematic view of index values and target values of an updated execution LUT according to an embodiment of the present invention. FIG. 6 is a schematic flow chart of a process for updating an execution LUT according to an embodiment of the present invention. Reference is made to FIGS. 5A-5E and FIG. 6 in order to illustrate Step S70 and the process for updating the execution LUT 44 of the multiple-interpolation lookup table device 40 in Step S80.

In this embodiment, it is assumed that target value data of up to four index values can be updated in one VBI, and 17 sets of index values and target values of the source LUT 42 are divided into five sub LUTs, namely, a first sub LUT, a second sub LUT, a third sub LUT, a fourth sub LUT, and a fifth sub LUT. The sub LUTs respectively update the content of the execution LUT 44 in five VBIs, namely, VBI-1 to VBI-5, as shown in FIG. 6.

The first sub LUT comprises target value data of index values x=0, 8, and 16, supports the 8-point interpolation method, and is used for updating the execution LUT 44 in the VBI-1. As shown in FIG. 5A, three points in the execution LUT 44 are updated, that is, the target value data of the index values x=0, 8, and 16 is provided. When the ISP 24 needs to look up the execution LUT 44 in the image processing, correct target values (y values) of the index values x=0, 8, and 16 can be obtained, and the execution LUT 44 has 8-point interpolation precision. When target values of index values x=1 to 7 or 9 to 15 are required, the multiple-interpolation lookup table device 40 obtains these target values by the 8-point interpolation method according to the target value data of the index values x=0, 8, and 16.

The second sub LUT comprises target value data of index values x=0, 4, 8, 12, and 16, supports the 4-point interpolation method, and is used for updating the execution LUT 44 in the VBI-2. As shown in FIG. 5B, two more points in the execution LUT 44 are updated, that is, the target value data of the index values x=4 and 12 is newly added. Therefore, the current multiple-interpolation lookup table device 40 has a total of five target value data of the index values x=0, 4, 8, 12, and 16, and the execution LUT 44 has 4-point interpolation precision. When target values of index values x=1 to 3, 5 to 7, 9 to 11, or 13 to 15 are required, the multiple-interpolation lookup table device 40 obtains these target values by the 4-point interpolation method according to the target value data of the index values x=0, 4, 8, 12, and 16.

The third sub LUT comprises target value data of index values x=0, 2, 4, 6, 8, 10, 12, 14, and 16, supports the 2-point interpolation method, and is used for updating the execution LUT 44 in the VBI-3. Likewise, as shown in FIG. 5C, four more points in the execution LUT 44 are updated, that is, target values of the index values x=2, 6, 10, and 14 are newly added. At this time, the multiple-interpolation lookup table device 40 has a total of nine target value data of the index values 0, 2, 4, 6, 8, 10, 12, 14, and 16, and the execution LUT 44 has 2-point interpolation precision. When target values of index values x=1, 3, 5, 7, 9, 11, 13, and 15 are required, the multiple-interpolation lookup table device 40 obtains these target values by the 2-point interpolation method according to the target value data of the index values x=0, 2, 4, 6, 8, 10, 12, 14, and 16.

After being updated for three times, the execution LUT 44 has nine sets of index values and corresponding target values. The remaining eight sets of data are unknown, that is, eight target values of the index values x=1, 3, 5, 7, 9, 11, 13, and 15 are unknown. However, since target value data of up to four index values can be updated in one VBI, at least two VBIs are required for updating. Therefore, the fourth sub LUT and the fifth sub LUT are respectively used to update the execution LUT 44 in the VBI-4 and the VBI-5. The fourth sub LUT comprises the target value data of the index values x=1, 3, 5, and 7, and the fifth sub LUT comprises the target value data of the index values x=9, 11, 13, and 15.

As shown in FIG. 5D, four points in the execution LUT 44 are updated in the VBI-4 according to the fourth sub LUT, that is, the target value data of the index values x=1, 3, 5, and 7 in the fourth sub LUT is newly added. At this time, the multiple-interpolation lookup table device 40 has data of the index values 0, 1, 2, 3, 4, 5, 6, 7, 8, 10, 12, 14, and 16, and when the target values of the index values x=9, 11, 13, and 15 are required, the multiple-interpolation lookup table device 40 obtains these target values by the 2-point interpolation method according to the target value data of the index values x=8, 10, 12, 14, and 16.

Finally, as shown in FIG. 5E, four points in the execution LUT 44 are updated according to the fifth sub LUT, that is, the target value data of the index values x=9, 11, 13, and 15 in the fifth sub LUT is obtained, thereby obtaining all of the content of the source LUT 42 as shown in FIG. 4. At this time, the multiple-interpolation lookup table device 40 has the target value data of all index values 0-16, so that the target value of all index values can be directly obtained without performing interpolation.

It should be noted that, as the execution LUT 44 is gradually updated and the interpolation precision of the multiple-interpolation lookup table device 40 is changed, the content of the multiple-interpolation lookup table device 40 becomes more accurate, and the obtained target values become closer to actual target values.

Moreover, although the update is performed in consecutive VBIs in the above embodiments, the execution LUT 44 does not need to be updated in consecutive VBIs in practice.

The present invention further provides another LUT update method. In addition to the concept of distributing the content of the execution LUT 44 to be updated into different VBIs for updating, the LUT update method further discloses how to enable the multiple-interpolation lookup table device 40 to have a lookup table function through a multiple-segment interpolation method.

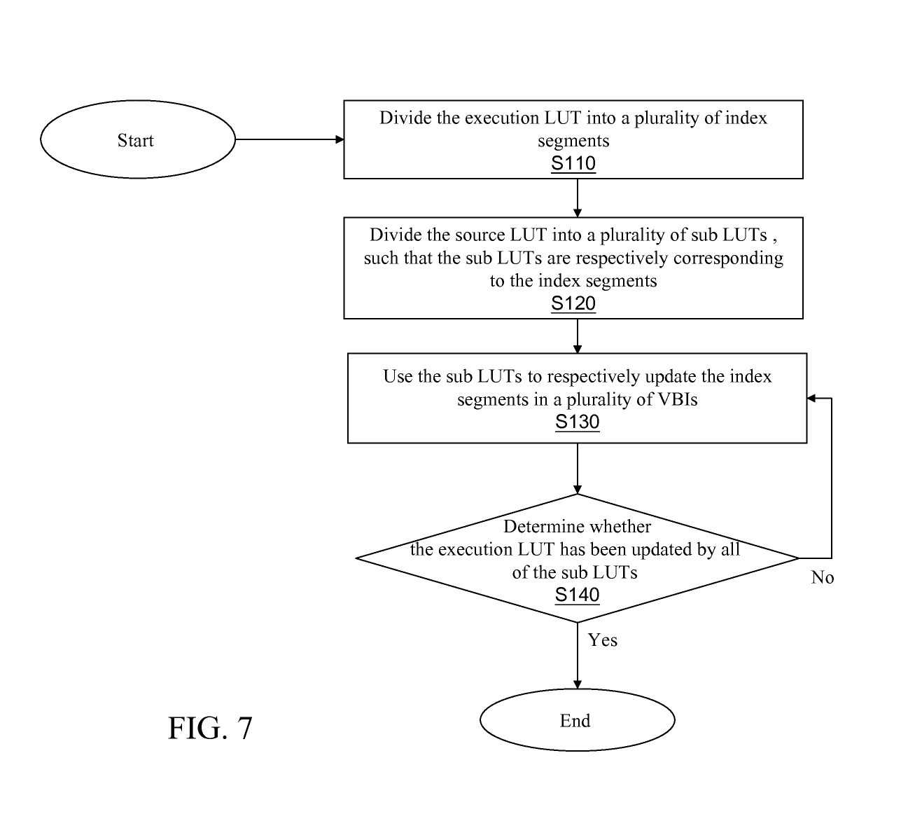

FIG. 7 is a schematic flow chart of an LUT update method according to another embodiment of the present invention. Referring to FIG. 7, the LUT update method comprises: Step S110, dividing the execution LUT into a plurality of index segments; Step S120, dividing the source LUT into a plurality of sub LUTs, such that the sub LUTs are respectively corresponding to the index segments; Step S130, using the sub LUTs to respectively update the corresponding index segments in the execution LUT in a plurality of VBIs; and Step S140, determining whether the execution LUT has been updated by all of the sub LUTs.

For example, when the user changes shooting environment parameters through the operation interface of the image processing apparatus 20, the content of the execution LUT 44 of the multiple-interpolation lookup table device 40 needs to be updated accordingly. At this time, the micro processor 23 sends an update command to the ISP 24, so as to further update the content of the execution LUT 44 in the multiple-interpolation lookup table device 40 according to content of the source LUT 42 stored in the storage 26.

Alternatively, when the user changes the display apparatus 30 connected to the image processing apparatus 20, the multiple-interpolation lookup table device 40 in the display engine unit 28 needs to be updated. At this time, the micro processor 23 sends an update command to the display engine unit 28, so as to update content of the execution LUT 44 of the multiple-interpolation lookup table device 40 in the display engine unit 28 according to the source LUT 42 stored in the storage 26.

In addition, as shown in FIG. 4, the source LUT 42 has 17 sets of index values and target values, and the details are as described above and thus will not be described again.

In Step S110, the execution LUT 44 is divided into a plurality of index segments. For example, the 17 index values may be divided into three index segments, namely, an index segment 0≦x≦4, an index segment 4≦x≦8, and an index segment 8≦x≦16.

In Step S120, the source LUT 42 is divided into a plurality of sub LUTs. For example, it is assumed that the execution LUT 44 is divided into three index segments for updating, the source LUT 42 may be divided into three sub LUTs (a first sub LUT, a second sub LUT, and a third sub LUT) corresponding to the three index segments of the execution LUT 44.

In Step S130, the sub LUTs are used to respectively update the corresponding index segments in the execution LUT 44 in a plurality of VBIs. The execution LUT 44 may be updated by the corresponding sub LUTs, such that the multiple-interpolation lookup table device 40 is corresponding to the N-point interpolation methods. After being updated by the sub LUTs, the execution LUT 44 may be corresponding to different N-point interpolation methods at the same time.

For example, the first sub LUT, the second sub LUT and the third sub LUT are respectively corresponding to the three index segments of the execution LUT 44, and respectively update the corresponding index segments in three VBIs. Furthermore, when the sub LUT supports an N-point interpolation method, after the index segment is updated by the sub LUT supporting the N-point interpolation method, the multiple-interpolation lookup table device 40 can obtain target values in the index segment by the N-point interpolation method. Here, N is 2^{m}, where m is an integer equal to or greater than 1.

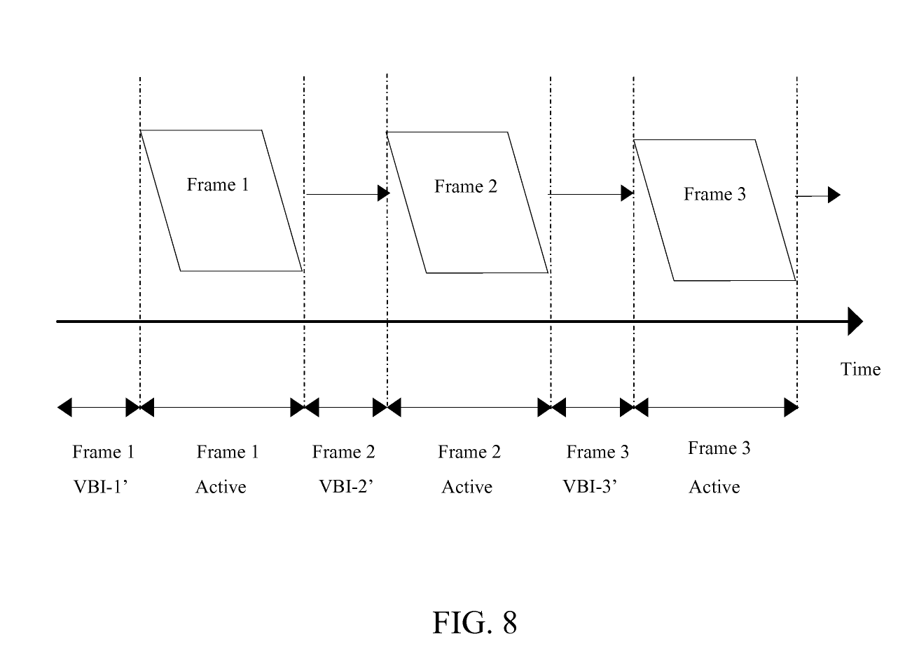

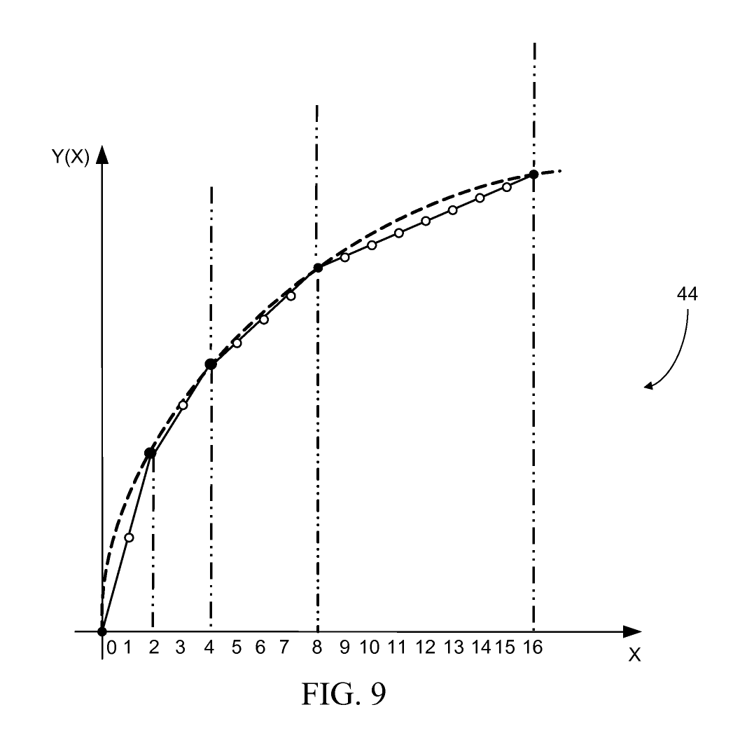

FIG. 8 is a schematic flow chart of a process for updating an execution LUT according to an embodiment of the present invention. As shown in FIG. 8, the first sub LUT, the second sub LUT, and the third sub LUT are respectively distributed into three VBIs, namely, VBI-1′, VBI-2′, and VBI-3′, for updating the corresponding index segments in the execution LUT 44. The updated execution LUT 44 is as shown in FIG. 9.

The first sub LUT comprises target value data of index values x=0, 2, and 4, supports the 2-point interpolation method, and is used for updating the index segment 0≦x≦4 of the execution LUT 44. After being updated by the first sub LUT, the execution LUT 44 has the target value data of the index values x=0, 2, and 4. Therefore, the multiple-interpolation lookup table device 40 can obtain target values in the index segment 0≦x≦4 by the 2-point interpolation method. The second sub LUT comprises target value data of index values x=4 and 8, supports the 4-point interpolation method, and is used for updating the index segment 4≦x≦8 of the execution LUT 44. After being updated by the second sub LUT, the execution LUT 44 further has the target value data of the index values x=4 and 8. Therefore, the multiple-interpolation lookup table device 40 can obtain target values in the index segment 4≦x≦8 by the 4-point interpolation method. The third sub LUT comprises target value data of index values x=8 and 16, supports the 8-point interpolation method, and is used for updating the index segment 8≦x≦16 of the execution LUT 44. After being updated by the third sub LUT, the execution LUT 44 further has the target value data of the index values x=8 and 16. Therefore, the multiple-interpolation lookup table device 40 can obtain target values in the index segment 8≦x≦16 by the 8-point interpolation method.

That is, after the execution LUT 44 is updated by the sub LUTs, the index segments of the execution LUT 44 may be corresponding to different N-point interpolation methods at the same time. Therefore, the multiple-interpolation lookup table device 40 is a multiple-segment interpolation lookup table device. In different segments of the multiple-interpolation lookup table device 40, target values can be obtained by interpolation methods having the interpolation precision corresponding to the index segments, thereby further achieving a progressive lookup table function.

In addition, the number and range of index segments into which the execution

LUT 44 is divided, as well as the interpolation precision required by the segments may be determined as required, which, however, is not limited to the above embodiments.

Finally, in the Step S140, it is determined whether the execution LUT 44 has been updated by all of the sub LUTs. If the execution LUT 44 of the multiple-interpolation lookup table device 40 has been completely updated (that is, the content of the source LUT 42 have been completely copied to the execution LUT 44), the execution LUT 44 does not need to be updated before a new update command is received. If the sub LUTs in the source LUT 42 have not been completely copied to the execution LUT 44, the execution LUT 44 is continuously updated in the next VBI until the multiple-interpolation lookup table device 40 has been updated by all of the sub LUTs.

It should be noted that, even if the execution LUT 44 has not been completely updated, if a new update command is received, the multiple-interpolation lookup table device 40 needs to be updated again by a newly specified source LUT 42 according to the new update command.

Moreover, although the update is performed in consecutive VBIs in the above embodiments, the execution LUT does not need to be updated in consecutive VBIs in practice.

Based on the above, the LUT update method of the present invention can gradually update the execution LUT of the multiple-interpolation lookup table device in the plurality of VBIs, and change the interpolation precision of the multiple-interpolation lookup table device. As such, after scene switching, the multiple-interpolation lookup table device can also provide in real time the result of looking up the execution LUT by the image processing apparatus. Furthermore, as the execution LUT is gradually updated, the multiple-interpolation lookup table device can output more precise interpolation results. Moreover, the LUT update method of the present invention does not require any additional registers or memories for pre-storing the execution LUT, and thus has low cost and low power consumption compared with the conventional update methods.

What is claimed is:

1. A look up table (LUT) update method, suitable for an image processing apparatus, wherein the image processing apparatus comprises a multiple-interpolation lookup table device having an execution LUT, and the LUT update method updates the multiple-interpolation lookup table device according to a source LUT, the LUT update method comprising:
dividing the source LUT into a plurality of sub look up tables (sub LUTs); and
using the sub LUTs to respectively update content of the execution LUT in a plurality of vertical blanking intervals (VBIs).

2. The LUT update method according to claim 1, wherein the sub LUTs are each corresponding to an N-point interpolation method, and the execution LUT is updated by the sub LUTs such that the multiple-interpolation lookup table device is corresponding to the N-point interpolation methods.

3. The LUT update method according to claim 2, wherein N is 2^{m}, and m is an integer equal to or greater than 1.

4. The LUT update method according to claim 1, further comprising: dividing the execution LUT into a plurality of index segments, wherein the sub LUTs are respectively corresponding to the index segments and respectively update the index segments in the VBIs.

5. The LUT update method according to claim 4, wherein the sub LUTs are each corresponding to an N-point interpolation method, and the index segments are updated by the corresponding sub LUTs such that the index segments of the multiple-interpolation lookup table device are corresponding to the N-point interpolation methods.

6. The LUT update method according to claim 5, wherein N is 2^{m}, and m is an integer equal to or greater than 1.

7. The LUT update method according to claim 5, wherein after the execution LUT is updated by the sub LUTs, the execution LUT is corresponding to the different N-point interpolation methods at the same time.

8. The LUT update method according to claim 1, wherein the multiple-interpolation lookup table device is disposed in an image signal processor (ISP) or a display engine unit of the image processing apparatus.

9. The LUT update method according to claim 1, wherein the execution LUT is a red-green-blue (RGB) table, a luminance-chrominance (YUV) table, a lens shading table, a liquid crystal display (LCD) gamma correction table, or a television gamma correction table.

10. The LUT update method according to claim 1, wherein the source LUT is a red-green-blue (RGB) table, a luminance-chrominance (YUV) table, a lens shading table, a liquid crystal display (LCD) gamma correction table, or a television gamma correction table.

11. The LUT update method according to claim 1, wherein the source LUT is stored in a storage of the image processing apparatus.
